(19) United States
(12) Patent Application Publication
(10) Pub. No.: US 2026/0287161 A1
(43) Pub. Date: Sep. 24, 2026

(54) Lamp with Adjustable Light Output Based on Detected Motion

(71) Applicant: LEDVANCE GmbH, Garching bei München (DE)

(72) Inventors: Wuqiang LIAO, Shenzhen Guangdong (CN); Heng LI, Shenzhen Guangdong (CN); Jiang WANG, Shenzhen Guangdong (CN)

(21) Appl. No.: 19/453,653

(22) Filed: Jan. 20, 2026

(30) Foreign Application Priority Data
Jan. 24, 2025 (CN) 202510122455.9

(51) Int. Cl. F21V 23/04; H05B 45/20; H05B 47/105; H05B 47/17; H05B 47/19

(52) U.S. Cl. CPC F21V 23/0492; H05B 45/20; H05B 47/105; H05B 47/17; H05B 47/19

(57) ABSTRACT

A lamp is disclosed. The lamp includes one or more light sources configured to generate light with at least one adjustable light parameter; a driver configured to drive at least one light source; and a control module configured to control the driver. The lamp includes at least one stationary part and at least one moving part. The lamp includes a motion detection system configured to capture a motion of the at least one moving part, and the motion detection system is operatively connected with a control module. The control module is configured to, at least partially based on the motion of the at least one moving part captured by the motion detection system, control the at least one light source.

### CROSS-REFERENCE TO RELATED APPLICATIONS

This patent application claims the benefit of and priority to Chinese Patent Application No. 202510122455.9, filed on Jan. 24, 2025, which is herein incorporated by reference in its entirety.

### FIELD OF THE DISCLOSURE

The technical field of the present disclosure generally relates to lamps. In particular, the present disclosure relates to lamps or lighting devices with adjustable light output.

### BACKGROUND

Lamps with adjustable light parameters, such as light-emitting diode (LED) lamps, are well known. It is also well known that lamps can be controlled by mobile applications or computers, such as via wireless or wired communication, physical buttons, knobs, or touch panels. However, it is usually difficult to strike a balance between professionalism and operability, which leads to low user interest. For example, computer-controlled lamps or application-controlled lamps require additional devices, components, or even the whole system to perform control operations, such that the whole system is not particularly user-friendly, especially for many simple applications. It is also well known that lamps can be controlled by gestures or voice. However, gesture-controlled lamps and voice-controlled lamps suffer from poor recognition and tend to misunderstand the user's intention.

### SUMMARY

A lamp is disclosed in the present disclosure which can be easily and intuitively controlled and can provide an improved user experience.

In order to solve the above problems, a lamp or lighting device is disclosed. The lamp includes one or more light sources with at least one adjustable light parameter. In particular, the lamp may include a plurality of tunable light sources to provide adjustable combined light effects.

The lamp also includes a driver configured to drive at least one light source. The driver may include a single-channel and/or multi-channel driver module for driving the at least one light source. The lamp also includes a control module or controller for controlling the driver.

The control module may include one or more lighting control modules for controlling a state of the at least one light source, in particular by correspondingly controlling the driver.

The lamp also includes at least one stationary part and at least one moving or movable part. The at least one stationary part may include a housing or a lamp body which has a bracket for positioning and/or a mounting seat for mounting itself on a mounting surface. The at least one moving part is configured such that it can be moved by a user, in particular, be moved relative to the at least one stationary part of the lamp.

The lamp further includes a motion detection system for capturing a motion of at least one moving part, and the motion detection system is operatively connected with the control module. The motion detection system may specifically include one or more sensors configured to capture translational motion, rotational motion, orientation and/or shaking of the at least one moving part. In particular, the motion detection system may include one or more gyroscopes, accelerometers and/or one or more additional sensors designed to detect the orientation and motion of the moving part.

The control module is configured to control the at least one light source based at least partially on the motion of the at least one moving part captured by the motion detection system.

In particular, the control module may be configured to control a light output of the at least one light source by correspondingly controlling the driver based at least partially on the motion captured by the motion detection system. The control module may be specifically configured to capture a current state of the lamp, such as a current operation or lighting state, and adjust the light output of the at least one light source based at least partially on the current state of the lamp. Specifically, depending on the current state of the at least one moving part and the motion captured by the motion detection system, the control module can turn on or off the lamps, start or stop the color cycle mechanism, and adjust correlated color temperature (CCT) and/or brightness of the output light.

The lamp is particularly comfortable and user-friendly because the lamp can be controlled by simply moving the at least one moving part and no additional device is needed to control the light output. Therefore, the user can simply move the moving parts to obtain interactive feedback to adjust the light output, thus improving usability and user experience. Therefore, the lamp is a simple, installation-free and game-controllable lighting device with enhanced user experience.

Therefore, the motion of at least one moving part can be interpreted by the motion detection system as a user command for controlling the lamp. The user's physical interaction with at least one moving part of the lamp can provide feedback to the lamp for changing a current operating mechanism of the lamp or adjusting the light output of the lamp. Usability and user experience of the lamp can be greatly enhanced by adopting such interactive feedback.

The at least one moving part may be designed to be smaller than a size of the lamp and/or configured such that the at least one moving part can be easily held in a hand for performing motion. Therefore, even a large lamp which is not suitable to be held in the hand can be easily controlled by limiting the motion to the at least one moving part.

As a result, the at least one moving part can thus act as an intelligent component in response to user interaction, so that a display or operating state of the lamp can be easily changed by simply moving (e.g., rotating or tapping) the intelligent component of the lighting device.

The motion detection system may include an inertial measurement unit (IMU) for capturing the motion of at least one moving part and a microcomputer unit (MCU) configured to convert the motion captured by the inertial measurement unit into a lighting command. The IMU may, in particular, include one or more gyroscopes and/or magnetometers configured to capture the motion of the at least one moving part induced by user actions, such as rotation and swinging. Thus, these actions can be converted into the lighting control commands by the MCU.

The motion detection system can be at least partially integrated in the control module of the lamp. A motion control capability can be easily realized in the lamp by integrating the IMU and MCU which controls the IMU into a single control module. In particular, the control module can be easily integrated into the lamp without any extensive mechanical or structural adaptation measures.

The at least one moving part may include at least one part movably attached to the at least one stationary part. In such an embodiment, the lamp can be controlled by moving the movably attached part relative to the at least one stationary part without separating them from each other.

In some embodiments, the at least one moving part includes at least one detachable moving part. In such an embodiment, the at least one moving part can be separated from at least one stationary part and thus can become an independent device, thereby realizing remote control of the lamp.

The at least one moving part of the lamp may include at least one functional element that facilitates the light performance of the lamp. Therefore, the functional element of the lamp can be converted into an intelligent component for controlling the lamp.

The at least one functional element may include at least one beam shaping element for shaping a radiation pattern of the lamp. In particular, an external optical element accessible to the user may be used as the intelligent component for controlling the lamp.

The motion detection system may be configured to capture information about direction, angle and/or speed of the motion of the at least one moving part. The control module may be configured to control the at least one light source based at least partially on the information about the direction, angle of the motion, speed of the motion and/or direction variation speed of the at least one moving part captured by the motion detection system. Therefore, the user may easily adjust or control the light output by moving the at least one moving part in different directions, at different speeds and/or at different angles.

In some embodiments, capturing the motion includes capturing a motion pattern of the motion of the at least one moving part, such as a trajectory and/or a rotation pattern. Therefore, the user may easily adjust or control the light output by moving the at least one moving part in different patterns or along different trajectories.

The lamp may be a configurable lamp with a variable lighting configuration. This allows lighting curve adjustment and gesture-specific customized configuration. For example, changes of light configuration may include selecting a human-centric lighting (HCL) curve, which represents time dependence of the light parameter, from a set of HCL curves stored in a memory unit of the control module according to the user's preference.

In some embodiments, the lamp includes one or more built-in configuration modules for changing the lighting configuration based at least partially on the motion captured by the motion detection.

Alternatively or additionally, the lamp may include one or more external configuration modules configured to change the lighting configuration based at least partially on input received from an external input device. The external input device may be a server, a personal computer, or any mobile device with a suitable user interface. The external input device can be wirelessly connected with the lamp based on Bluetooth or other protocols, and/or wired with the mobile lamp through a corresponding interface of the lamp.

In some embodiments, at least one stationary part of the lamp is configured as a detachable and/or movably mounted lamp body. Specifically, the stationary part or the lamp body may be attached to or detached from a mounting surface according to the user's wishes. Further, the lamp body can be movable in an installed state, that is, even without detaching the lamp body from the mounting surface. Therefore, even if a position of the lamp is not changed, the lamp can be moved as a whole.

In some embodiments, the stationary part includes a mounting seat configured to mount the lamp on a substantially flat mounting surface. Principally, the mounting surface may be any suitable surface in, for example, any position where it is desired to place the lamp. The mounting surface may be, for example, a wall surface or a ceiling surface, a bottom surface of a shelf or a cabinet, or any inner surface of a cabinet (for example, a cupboard or wardrobe).

The mounting seat may include magnetic material or a magnet for magnetically attaching the stationary part of the lamp to the mounting surface. Due to the magnetic material in the mounting seat or the magnetic seat, the lamp can be easily (in particular, without using a tool) attached to the mounting surface of a metal support or a support including a magnetic material (in particular, a ferromagnetic material). In some embodiments, the lamp may include a detachable magnetic plate and/or an adhesive film for mounting the lamp on the mounting surface. Due to the magnetic plate and/or adhesive tape, the lamp can also be easily mounted to any non-magnetic support.

In some embodiments, the lamp includes at least one power supply unit, in particular, which has a rechargeable battery for autonomous power supply of the at least one stationary part and/or at least one moving part of the lamp. Because of the autonomous power supply, the lamp can even work in places where there is no direct access to the grid. The lamp may include one or more power ports and/or inductive charging ports for connecting the lamp (specifically, at least one stationary part and/or at least one moving part) to an external power supply. In some embodiments, a universal serial bus type-C (USB-C) compact port is used as the power port. The autonomous power supply can be charged when necessary by connecting the power port to an external power supply.

In some embodiments, the lamp includes a communication interface for receiving the user command, and the control module may be configured to control the driver based at least partially on the user command received via the communication interface. In particular, the control module may be configured such that the at least one light parameter is adjusted according to the user command received via the communication interface.

The communication interface may be configured for wireless communication with a communication interface of an intelligent device having a user interface, so that the control module may be configured based at least partially on a user input received via a user interface of a mobile device. In particular, the control module may be configured such that settings of lamps (e.g., preset light scenes) can be modified by the user using, for example, proprietary applications installed on the mobile devices.

In the following description, details are provided to describe embodiments of this specification. However, it will be apparent to those skilled in the art that the embodiments may be practiced without these details.

Some parts of the embodiment share similar parts. Similar parts may have the same name or similar part numerals. Where appropriate, the description of one part is applied to another similar part by reference, thus reducing the repetition of text without limiting the present disclosure.

### BRIEF DESCRIPTION OF THE DRAWINGS

FIG. 1 shows a schematic perspective view of a lamp according to an embodiment.

FIG. 2 shows a schematic side view and a top view of a lamp according to another embodiment.

FIG. 3 shows a schematic perspective view of a lamp according to another embodiment.

FIG. 4 shows a schematic perspective view of a lamp according to yet another embodiment.

FIG. 5 shows a schematic top view of a lamp according to another embodiment.

FIG. 6 shows a schematic side view of the lamp according to FIG. 5.

FIG. 7 illustrates operation of a lamp according to an embodiment.

FIG. 8 shows some translational motions that can be used to control the lamp.

FIG. 9 shows some rotational motions that can be used to control the lamp.

FIG. 10 shows an exemplary implementation of motion control according to an embodiment.

FIG. 11 shows another exemplary implementation of motion control according to an embodiment.

FIG. 12 shows a side view of a lamp according to an embodiment.

FIG. 13 shows a perspective exploded view of a lamp according to an embodiment.

FIG. 14 shows a schematic block diagram of a lamp according to an embodiment.

FIG. 15 shows a process of an external configuration according to an embodiment.

### DETAILED DESCRIPTION

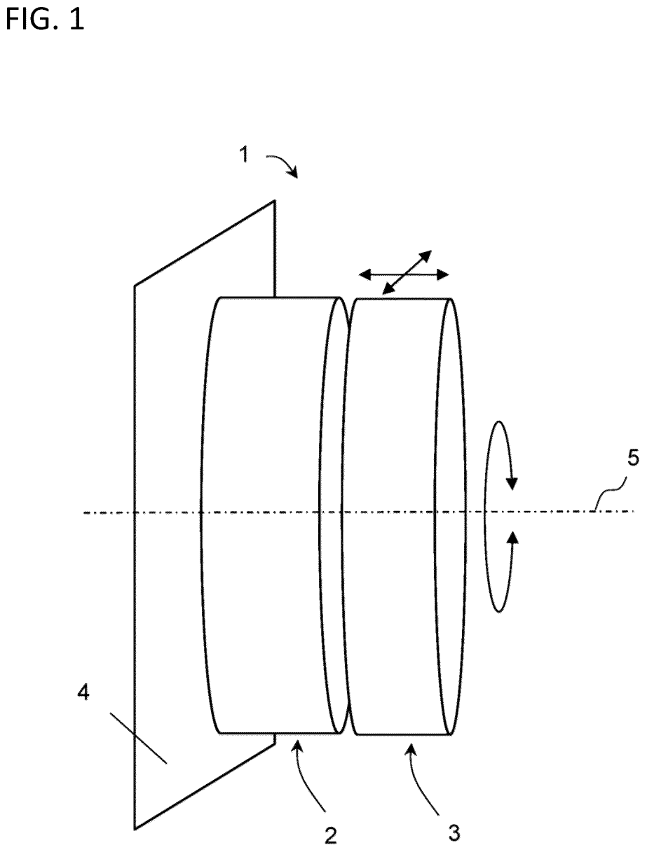

FIG. 1 shows a schematic perspective view of a lamp 1 according to an embodiment. In the illustrated embodiment, a lamp 1 includes a substantially disc-shaped stationary part 2 and a substantially disc-shaped moving part 3 attached to the stationary part 2. The stationary part 2 of the lamp 1 is mounted on a substantially flat mounting surface 4. The lamp 1 with rotational symmetry has an axis of symmetry 5 substantially perpendicular to the mounting surface 4, the stationary part 2 and the moving part 3.

The moving part 3 is movably attached to the stationary part 2 such that the moving part 3 can be manually moved relative to the stationary part 2.

The lamp 1 is configured such that an operation of the lamp 1 can be controlled by moving the moving part 3 relative to the stationary part 2.

In particular, the lamp 1 includes a light source 6, a driver 21 configured to drive the light source 6, a control module 30 and a motion detection system 22 operatively connected to the control module 30 so that the lamp 1 can be controlled by the control module 30 based on a motion of the moving part 3 captured by the motion detection system 22.

In the illustrated embodiment, the moving part 3 is attached to the stationary part 2 in such a way that the moving part 3 can perform translational and/or rotational motions indicated by arrows at least within a certain range. In some embodiments, the moving part 3 can rotate around the axis of symmetry 5 without any angular restriction.

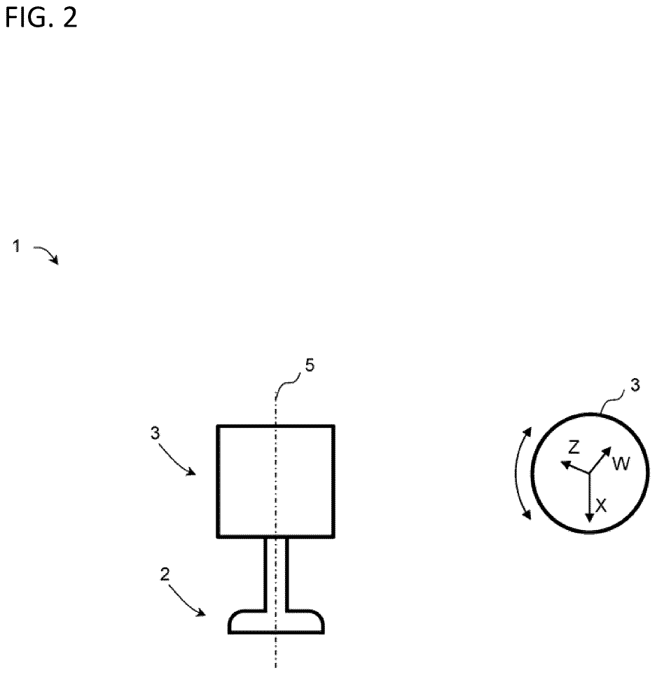

FIG. 2 shows a schematic side view and a top view of a lamp 1 according to another embodiment.

In the embodiment of FIG. 2, the lamp 1 is configured as an axisymmetric desk lamp with a vertical axis of symmetry 5. The lamp 1 includes a stationary part 2 in the form of a lamp holder and a moving part 3 configured as a lamp shade which is movably mounted on the lamp holder.

On the right side of FIG. 2, a schematic top view of lamp 1 is shown. The arrows on the right side of the figure indicate an exemplary motion mode that the moving part 3 can perform under physical interactions from a user.

In particular, the lamp shade can move up, down, sideways, and/or in an oblique direction relative to the lamp holder, as indicated by directional arrows which indicate horizontal motion (arrow X), vertical motion (arrow Z), and oblique motion (arrow W) respectively.

In addition, the lamp shade can be rotated clockwise and/or counterclockwise, as indicated by curved arrows.

The motion of the moving part 3 can be converted into a lighting command, such as on/off, horizontal (brightness) adjustment, CCT adjustment, scene adjustment, color cycle exchange, animation, etc., thereby realizing intuitive and user-friendly operation of the lamp 1.

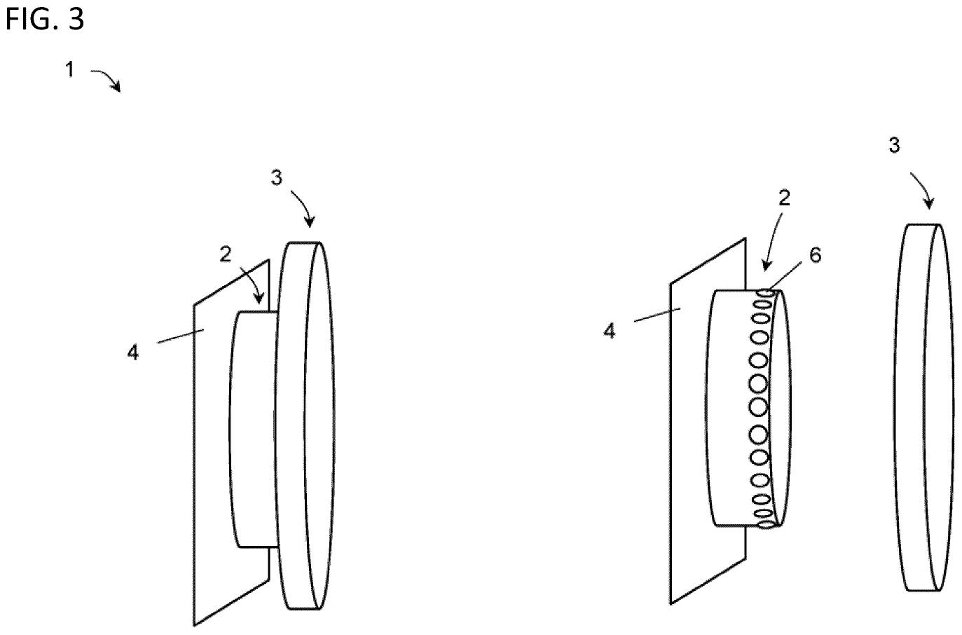

FIG. 3 shows a schematic perspective view of a lamp 1 according to another embodiment. In the embodiment of FIG. 3, lamp 1 basically corresponds to the embodiment of FIG. 1, in which the moving part 3 is configured as a removable part that can be separated from the stationary part 2.

On the right side of FIG. 3, the moving part 3 is separated from the stationary part 2 to illustrate more details of the lamp 1. In particular, the lamp 1 includes a plurality of light sources 6 arranged around the stationary part 2 in a circular manner.

Similar to the embodiment of FIG. 1, both the stationary part 2 and the moving part 3 have a disc shape, and the moving part 3 has a larger diameter than that of the stationary part 2, so that the moving part 3 can be used as a lamp shade which at least partially covers the light source 6 from the outside.

In some embodiments, the moving part 3 is configured as a light shaping element, in particular as an at least partially translucent and/or transparent optical element. For example, the moving part 3 may include a diffusely scattering optical body, so that light generated by the plurality of light sources 6 may be diffusely scattered by the moving part 3. In some embodiments, the moving part 3 may include a pre-reflective coating for light, so that light diffusely scattered inside the main body can escape from a circumferential side wall of the moving part 3.

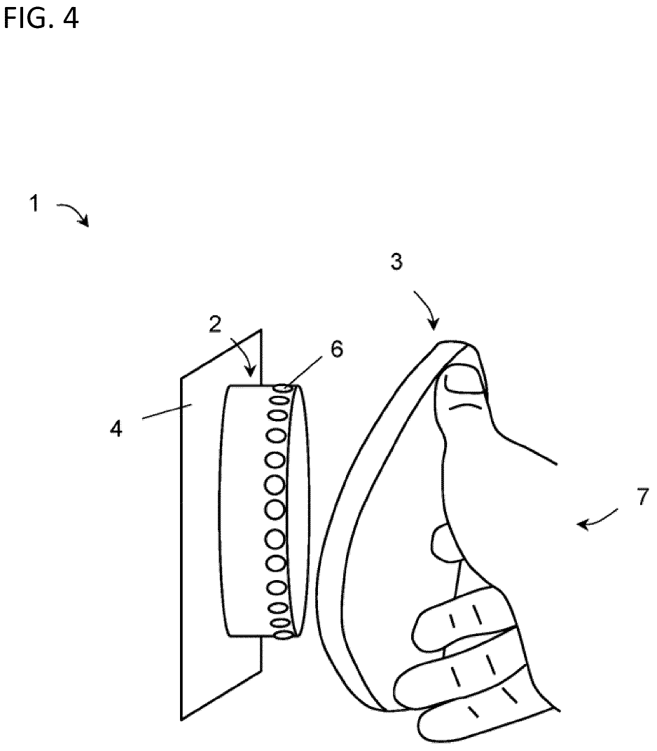

FIG. 4 shows a schematic perspective view of a lamp 1 according to yet another embodiment. The embodiment of FIG. 4 basically corresponds to the embodiment of FIG. 3, in which the moving part 3 is configured as a bendable or deformable part, which can be manually deformed by a user.

In particular, FIG. 4 shows that a hand 7 holds the moving part 3 of the lamp 1 in a state where the moving part 3 is deformed and separated from the stationary part 2.

In some embodiments, the moving part 3 is elastically deformable, so that after the physical impact has ended, the moving part 3 regains its original shape, such as a disk shape. The deformable moving 3 parts may include silicone and/or plastic materials, which are easily deformable and can also be used as translucent and/or transparent optical media.

In some embodiments, the moving part 3 can be magnetically attached to the stationary part 2, so that the moving part 3 can be easily separated from the stationary part 2 by pulling the moving part 3 away from the stationary part 2, as shown in FIGS. 3 and 4 above. Internal circuits of the stationary part 2 and the moving part 3 can be connected to each other, for example, via connectors, metal contacts and/or wireless or inductive coupling.

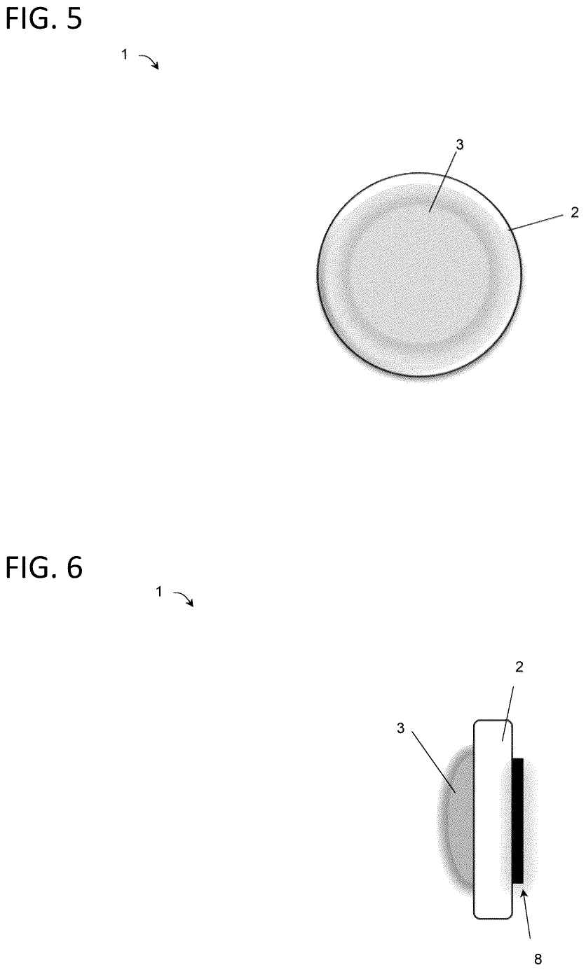

FIG. 5 shows a schematic top view of a lamp 1 according to another embodiment. The lamp 1 includes a stationary part 2 configured as the housing, a moving part 3 configured as a translucent optical cover, and a light source 6 in the housing behind the translucent optical cover. The lamp 1 includes a motion detection system 22, a driver 21 configured to drive a light source 6, a control module 30 configured to control light output of the light source 6, and a power supply unit 40 or battery for autonomous power supply of the lamp 1. These components are not shown in FIG. 5.

FIG. 6 shows a schematic side view of the lamp 1 according to FIG. 5. As seen from the side view of FIG. 6, the lamp 1 has a flat bottom or mounting seat 8 opposite to the translucent optical cover (moving part 3), which has a dome shape with a convex profile. The mounting seat 8 may include a magnetic material or a magnet and/or an adhesive for mounting the lamp 1 on a substantially flat surface.

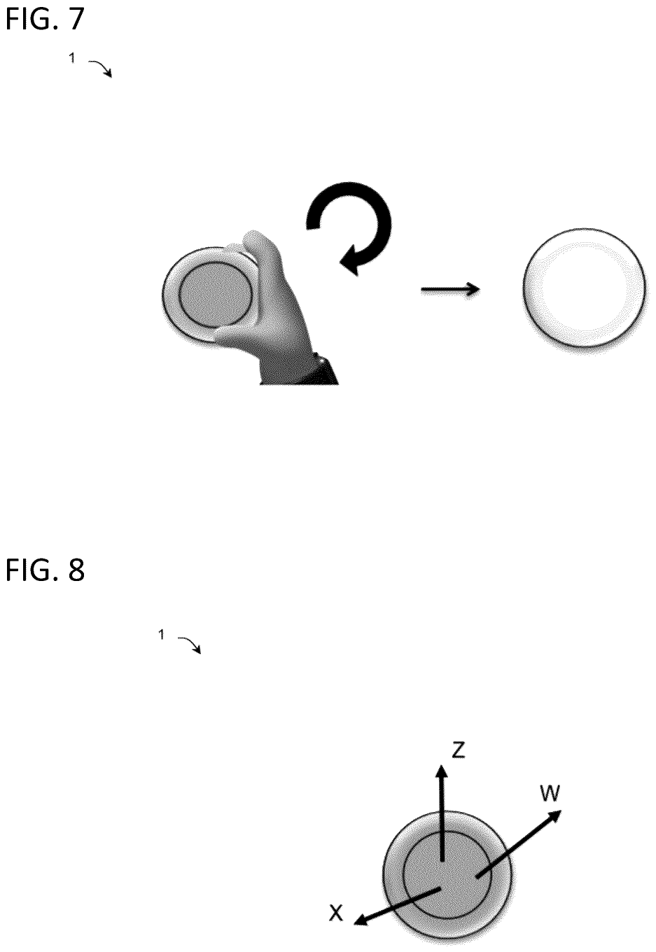

FIG. 7 illustrates operation of a lamp 1 according to an embodiment. Specifically, FIG. 7 shows a lamp 1 that can be fixed to a mounting surface 4 with a magnet, so that the moving part 3 and/or the whole lamp 1 can be moved or rotated by a user. In this illustrative example, a rotational motion caused by a user's hand 7 (on the left side of FIG. 7) indicated by a circular arrow is detected by a motion detection system 22, and a light source 6 is turned on by a control module 30, corresponding to a state shown on the right side of FIG. 7. Basically, depending on configuration, it can be any other motion, for example, it can be a combination of translational motion and/or rotational motion and/or shaking used by the user to control the lamp 1.

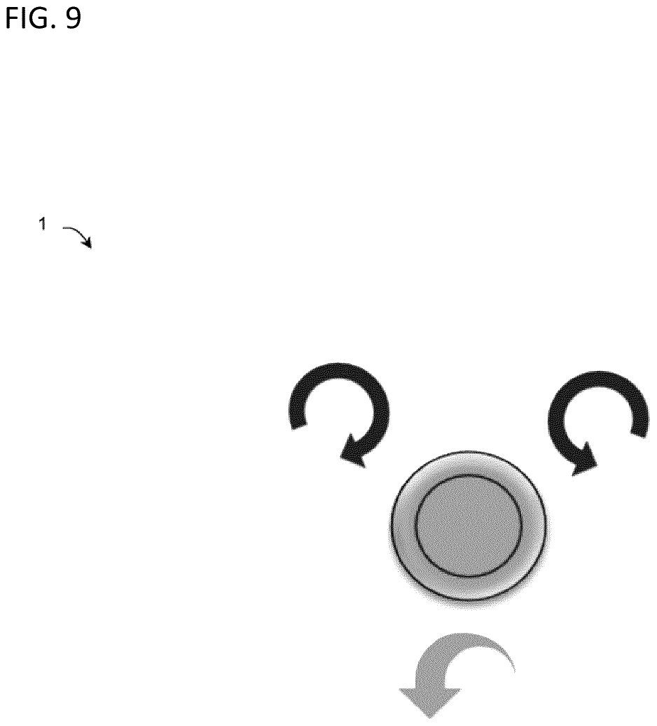

FIG. 8 shows some translational motions that can be used to control the lamp 1. Specifically, FIG. 8 shows a top view of lamp 1 according to an embodiment, in which arrows X, Z, and W respectively represent horizontal motion (arrow X), vertical motion (arrow Z), and oblique motion (arrow W). In some embodiments, a motion detection system 22 may be configured to capture such translational motion of a moving part 3 and/or the entire lamp 1, and a control module 30 may be configured to control or adjust a light output of the lamp 1 accordingly. In particular, the control module 30 may be configured to interpret the captured translational motion as a user command for controlling the light output of the lamp 1.

FIG. 9 shows some rotational motions that can be used to control the lamp 1. Specifically, FIG. 9 shows a top view of a lamp 1 according to an embodiment, wherein the circular arrow indicates a rotational motion of a moving part 3 or the lamp 1.

Specifically, the moving part 3 and/or the whole lamp 1 can rotate clockwise (indicated by the circular arrow at the upper left corner of FIG. 9) or counterclockwise (indicated by the circular arrow at the upper right corner of FIG. 9). The lamp 1 can also be rotated in alternate directions, for example, to perform trigger rotation, as indicated by the arrow at the bottom of FIG. 9.

The motion detection system 22 may be configured to capture such rotational motion and/or trigger motion of the moving parts 3 and/or the whole lamp 1, and the control module 30 may be configured to control or adjust a light output of the lamp 1 accordingly. Specifically, the control module 30 may be configured to interpret the captured rotational motion as a user command to control the light output of the lamp 1.

In some embodiments, a control module 30 is configured to control the light output of the lamp 1 based at least in part on direction, speed and/or rhythm of a translational motion and/or a rotational motion.

Specifically, the direction, speed and/or rhythm of the translation motion and/or rotational motion can be interpreted by a control module 30 as commands such as adjusting lighting level, turning on/off lights, adjusting CCT, changing lighting scene or color cycle, starting/stopping animation, etc.

FIG. 10 illustrates an exemplary implementation of motion control according to an embodiment. In the exemplary embodiment of FIG. 10, three different lighting states of the lamp 1 are shown. In the leftmost position in FIG. 10, the lamp 1 in an initial state, for example, generates light with a specific color temperature. Later, a left rotation of a moving part 3 of the lamp 1 is performed by a user.

A left rotation (indicated by a solid circular arrow) is detected by the motion detection system 22. The control module 30 interprets the left rotation as a command to lower the cooler temperature, for example, based on a look-up table stored in a memory unit 32 of the control module 30, so that the lamp 1 enters a second state (the middle position in FIG. 10) in which the lamp 1 generates cooler light. After that, the user holds the moving part 3 and/or the whole lamp 1 to draws a circle clockwise (indicated by an open circular arrow), which is detected by the motion detection system 22.

The control module 30 interprets the circular motion as a command to gradually increase brightness of output light of the lamp 1, for example, based on the look-up table stored in the memory unit 32 of the control module 30, resulting in a third state (rightmost state in FIG. 10). Transitions from the first state to the second state and from the second state to the third state are indicated by horizontal arrows. According to an embodiment, motion control can be realized by moving a moving part 3 relative to a stationary part 2 or by moving a lamp 1 as a whole.

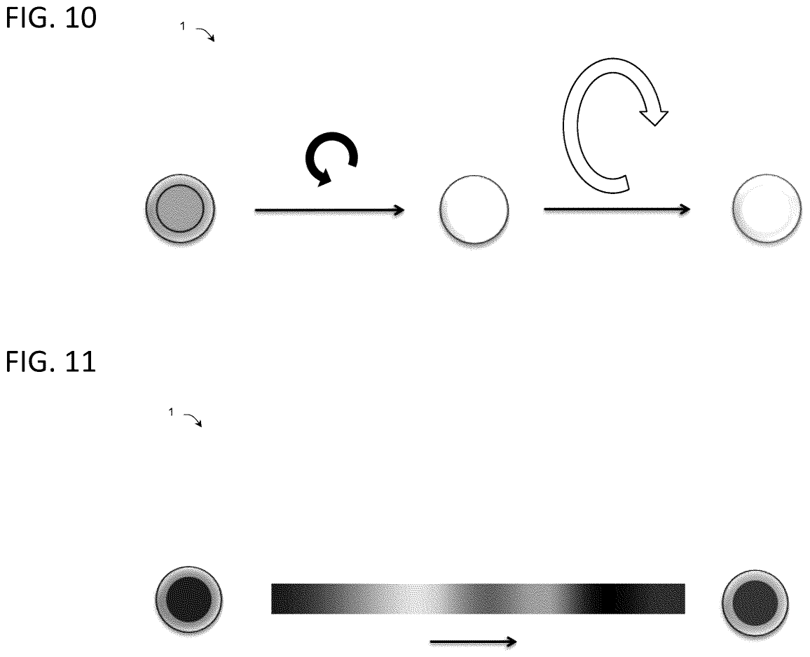

FIG. 11 shows a further exemplary implementation of motion control according to an embodiment. In the exemplary embodiment of FIG. 11, a lamp 1 is in a first state, for example, in which it generates light with a first spectral characteristic. Then, the moving part 3 and/or the whole lamp 1 are shaken, and the shake is detected by a system and interpreted by a control module 30 as a command to run a color cycle. Then, the control module 30 makes the lamp 1 enter the color cycle state (right side in FIG. 11) from the first state (left side in FIG. 11). In the color cycle mode, spectral characteristics of light are changed steadily, so that a color of light changes gradually. The transition from the first state to a second (color cycle) state is indicated by a horizontal arrow.

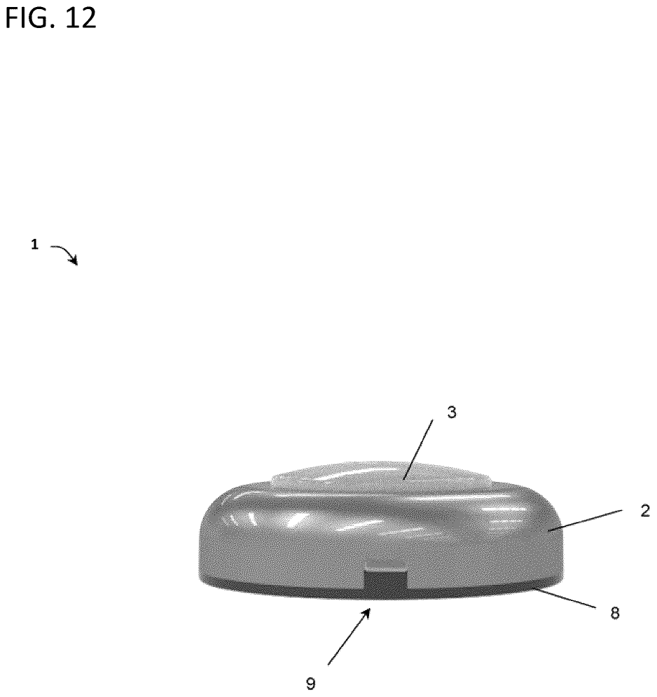

FIG. 12 shows a side view of a lamp 1 according to an embodiment. In the embodiment shown, the lamp 1 includes a power supply port 9 in a lower part of the housing.

In some embodiments, the moving part 3 in the form of a translucent optical cover is configured as a button that can be manually operated by a user. Specifically, the translucent optical cover can be deformed or displaced by, for example, pressing down toward a mounting seat 8, so that at least one mechanical switch (not shown) can be activated, which can be recorded by the control module 30 as a user input of the control module 30. Therefore, pushing the translucent optical cover (moving part 3) can serve as an additional input, especially in addition to motion control, to control the mobile lamp 1.

The lamp 1 may include a PCB (printed circuit board) on which a light engine is mounted. The light engine may include a plurality of LEDs mounted on a PCB. In some embodiments, the light engine includes one or more red, green, blue and/or white LEDs with different color temperatures.

Light with different colors and/or white light with different color temperatures can be generated by combining light generated by red, green and white LEDs in different proportions.

The lamp 1 may include a power supply unit 40 with a rechargeable battery. The power supply unit 40 can be connected to the power supply port 9, so that the rechargeable battery of the power supply unit 40 can be charged by connecting the lamp 1 to an external power supply by means of the power supply port 9.

On a bottom side of a mounting seat 8, an adhesive tape 17 may be provided for attaching the mounting seat 8 and/or a magnetic plate 18 (not shown) to a mounting surface 4. In some embodiments, the adhesive tape 17 is a double-sided adhesive tape, and a non-sticky removable foil is provided on one or both sides of the adhesive tape 17. In some embodiments, a non-adhesive removable foil is provided on one side of the adhesive tape 17, and the other side of the adhesive tape 17 is attached to the magnetic plate 18.

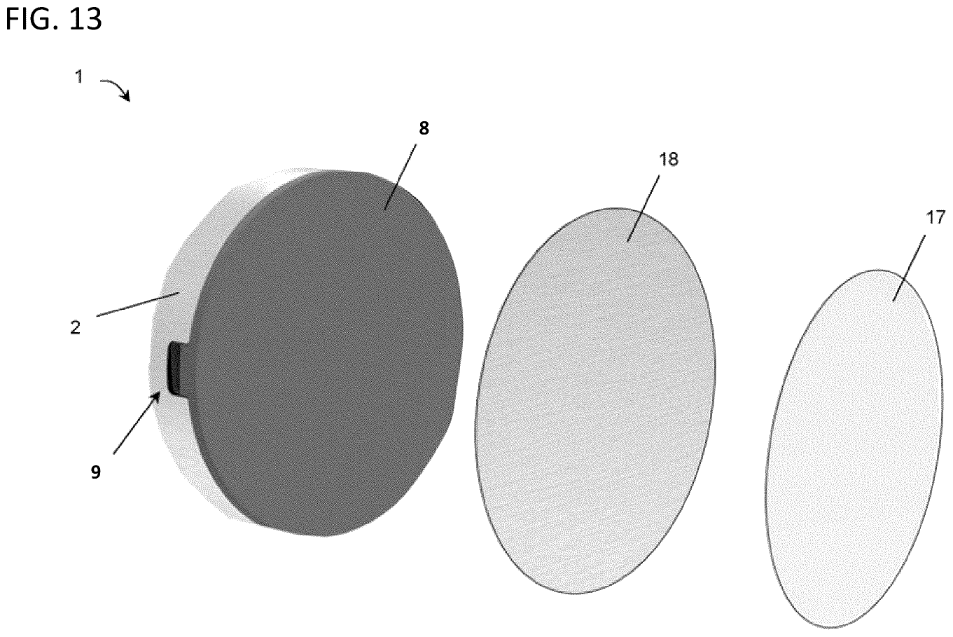

FIG. 13 shows a perspective exploded view of a lamp 1 according to an embodiment. Specifically, for the sake of clarity, FIG. 13 shows an adhesive tape 17 and a magnetic plate 18 in a separated state. In some embodiments, a 3M (Minnesota Mining and Manufacturing Company)-brand adhesive tape is used.

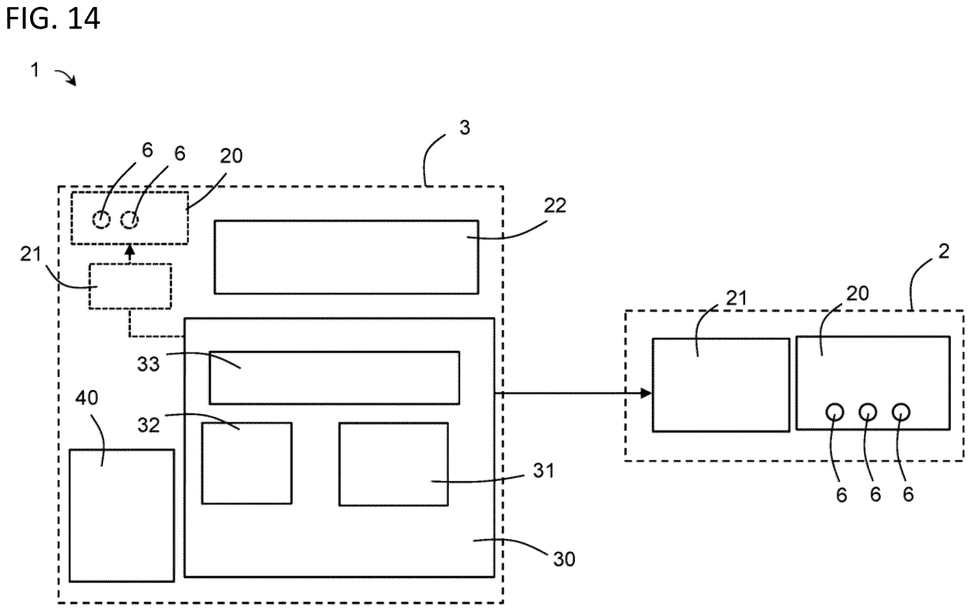

FIG. 14 shows a schematic block diagram of a lamp 1 according to an embodiment.

Some functional parts are realized in the stationary part 2, while some functional parts are realized in the moving part 3.

In this embodiment, the stationary part 2 includes a tunable optical module 20, which may include a plurality of light sources 6 with adjustable optical parameters. The stationary part 2 further includes a driver 21 configured to drive the optical module 20. In some embodiments, the driver 21 is a multi-channel driver configured to drive individual light sources 6 (e.g., LED light sources with different colors, such as red, green, blue, and white LEDs) to generate combined light with desired spectral characteristics.

The moving part 3 of the lamp 1 includes a motion detection system 22 having one or more sensors configured to detect a motion of the moving part 3 of the lamp 1. The motion detection system 22 may specifically include an IMU, one or more gyroscopes, accelerometers, and/or one or more additional sensors designed to detect orientation and motion of the moving part 3, particularly with respect to the stationary part 2 of the lamp 1.

The moving part 3 of the lamp 1 further includes a control module 30, which includes a processor 31, a memory unit 32 and a communication interface 33 configured to communicate with the motion detection system 22 and the driver 21 configured to drive the light source 6.

The lamp 1 further includes a power supply unit 40 for autonomous power supply of the moving parts 3 of the lamp 1. The power supply unit 40 may include a rechargeable battery and a power supply port 9 configured to connect the power supply unit 40 with an external power supply.

According to an embodiment, the stationary part 2 and the moving part 3 may be connected via wired or wireless communication. In particular, the control module 30 of the moving part 3 and the driver 21 of the stationary part 2 may be connected via wired or wireless communication based on different communication protocols.

For example, the stationary part 2 and the moving part 3 may be configured to communicate via serial peripheral interface (SPI), inter-integrated circuit (I2C), universal asynchronous receiver/transmitter (UART), and/or single wire serial (SWS) communication protocols. In some embodiments, pulse width modulation (PWM) of LED light source is applied in order to adjust the light output of the lamp 1.

In some embodiments, the wireless communication between the stationary part 2 and the moving part 3 is established based on near-field communication (NFC), Bluetooth low-energy (BLE), or another wireless communication protocol.

In some embodiments, power supply port 9 is configured for wireless coupling (especially inductive coupling) with a power source or an external power source in the stationary part 2.

Alternatively, or at least in some embodiments, the moving part 3 may also include an optical module 20 with one or more light sources 6, in particular, at least one adjustable light parameter and a driver 21 configured to drive the optical module 20. The control module 30 may accordingly be configured to control the optical module 20 of the moving part 3. In FIG. 14, an optional optical module 20 and the light source 6 of the moving part 3 are shown in dotted lines.

In some embodiments, the stationary part 2 further includes a motion detection system 22 and a control module 30, and in particular, it is similar to the moving part 3, so that a lighting operation of the stationary part 2 can be controlled by moving the stationary part 2. This feature may be particularly useful for lamps 1 having separable moving parts 3 which are far away from the stationary parts 2 of the lamps 1. In this case, a user can still control the lamp 1 by manipulating (especially moving) the stationary parts 2 according to predefined motion modes.

Memory unit 32 is configured to store data and machine-readable instructions for processor 31 for controlling driver 21. Specifically, the memory unit 32 may store instructions for the processor 31 to evaluate data received from motion detection system 22 in order to interpret a motion captured by the motion detection system 22, and control the light output of the lamp 1 by controlling the driver 21 based at least partially on the motion captured by the motion detection system 22.

In some embodiments, memory unit 32 may contain instructions for processor 31 to identify a motion pattern based on motion captured by the motion detection system 22. Further, the memory unit 32 may contain at least one look-up table that assigns a motion or motion pattern to an instruction to the processor 31 to control the driver 21, so that light source 6 can be controlled based on the motion or motion pattern recognized by the processor 31.

In some embodiments, motion detection system 22 may include additional sensors, in particular, for capturing additional actions of a user. For example, in the case of a deformable moving part 3 (refer to FIG. 4 above), the motion detection system 22 may include one or more deformation sensors, such as piezoelectric sensors, embedded in a deformable body of the moving part 3. Deformation of the moving part 3 caused by the user's action can be captured by the deformation sensors. The control module 30 may be configured to control the light source 6 based at least partially on the deformation captured by the deformation sensors. Therefore, in addition to motion control, the deformation of the moving part 3 can be used to control the lamp 1, thus making the lamp 1 more flexible and user-friendly.

In some embodiments, the lamp 1 includes one or more lighting configuration modules, which may be a part of the control module 30 or a separate module. The lighting configuration module may be configured to change the lighting or operation configuration of the lamp 1 based at least partially on the motion captured by the motion detection system 22.

The lamp 1 may alternatively or additionally include one or more external configuration modules for configuring the lamp 1 based at least partially on an input received from an external input device or configurator. Specifically, in some embodiments, more complex operations can be realized by connecting the external configurator 50. For example, the external configurator 50 can be used to configure shaking actions, for example, customizing actions which switch curves customize curves (such as HCL curves) and bind them to the device through Bluetooth. External configuration can be done in factory and/or provided by a user.

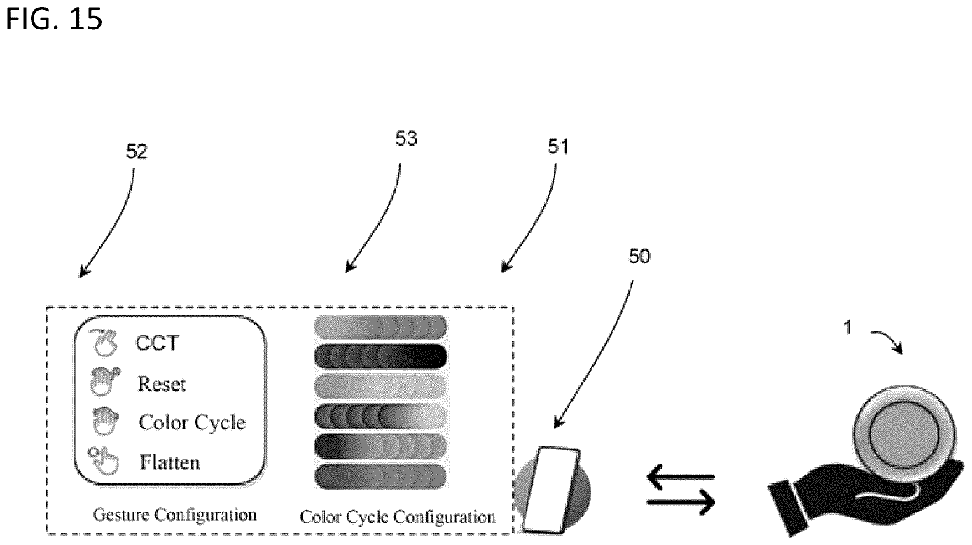

FIG. 15 shows a process of external configuration according to an embodiment. Specifically, FIG. 15 shows a lamp 1 according to an embodiment and an external configurator 50 having a user interface 51 menu for performing external configuration of the lamp 1. In this exemplary embodiment, the user interface 51 includes a gesture configuration field 52 and a color cycle configuration field 53. A user can configure the lamp 1 according to his preference by touching corresponding icons in the gesture configuration field 52 and the color cycle configuration field 53.

Therefore, the user can easily change operation or display state of the lamp 1 through simple motion (e.g., rotation) of the moving part 3 of the lamp 1, thereby providing an intuitive operation experience.

In addition, the operation of the lamps 1 is easy and direct, eliminating needs for complicated steps and reducing learning curves.

In addition, the lamps 1 presented herein do not need to be permanently installed, allowing users to carry and use the lamps 1 at any time, thus enhancing flexibility and portability.

In addition, the lamps 1 allow a high degree of freedom in configuration and customization. Specifically, users are free to configure and customize the lamps 1 according to their personal needs, thus meeting different environmental and situational requirements and providing greater flexibility. This versatility extends to various modes, including cheering LED sticks, toy lighting, night lights, wireless controllers and so on.

In addition, the lamps 1 are characterized by efficient state switching. The device realizes more state switches with no or fewer buttons and external control devices, which improves operation efficiency and reduces the complexity. In addition, the lamps 1 are characterized by real-time feedback and motion mode, which provides a high level of playability.

The lamps 1 proposed herein allow a high degree of freedom in configuration and customization. Users may freely configure and customize devices according to their own personal needs, thus meeting different environmental and situational needs and providing greater flexibility. This versatility and playability may be extended to various modes, including cheering LED sticks, toy lighting, night lights, wireless controllers and so on.

In addition, due to direct physical interaction between the users and the lamps 1, the lamp control is particularly simple, robust and reliable. In addition, the lamps 1 do not require any network configuration operations that are usually required by wireless devices.

The lamps 1 allow seamless integration. In particular, the control module 30 may be easily integrated into the lamps 1 without special mechanical or structural requirements.

The lamps 1 are particularly simple to handle and operate. Operation is direct and user-friendly, eliminating needs for complicated steps and reducing learning curves. In addition, users may easily change display state of the lighting device by simply moving, rotating the lighting device or using a controller, thus providing an intuitive operation experience.

Although at least one exemplary embodiment has been given in the above detailed description, it should be understood that there are numerous variations. It should also be understood that one or more exemplary embodiments are merely examples and are not intended to limit the scope, applicability or configuration of the present disclosure in any way. Rather, the foregoing detailed description will provide those skilled in the art with a convenient road map for implementing one or more exemplary embodiments.

Reference Signs and Numerals

| | |
|---|---|
| 1 | lamp |
| 2 | stationary part |
| 3 | moving part |
| 4 | mounting surface |
| 5 | axis of symmetry |
| 6 | light source |
| 7 | hand |
| 8 | mounting seat |
| 9 | power supply port |
| 17 | adhesive tape |
| 18 | magnetic plate |
| 20 | optical module |
| 21 | driver |
| 22 | motion detection system |
| 30 | control module |
| 31 | processor |
| 32 | memory unit |
| 33 | communication interface |
| 40 | power supply unit |
| 50 | external configurator |
| 51 | user interface |
| 52 | gesture configuration field |
| 53 | color cycle configuration field |
| x | horizontal motion |
| y | vertical motion |
| z | oblique motion |

What is claimed is:

1. A lamp comprising:
at least one light source configured to generate light with at least one adjustable light parameter;
a driver configured to drive the at least one light source;
at least one stationary part;
at least one moving part;
a motion detection system configured to capture a motion of the at least one moving part; and
a control module configured to control the at least one light source at least partially based on the motion of the at least one moving part captured by the motion detection system.

2. The lamp according to claim 1, wherein the motion detection system comprises:
an inertial measurement unit configured to capture the motion of the at least one moving part; and
a microcomputer unit configured to convert the motion captured by the inertial measurement unit into a lighting command.

3. The lamp according to claim 1, wherein the motion detection system is at least partially integrated in the control module.

4. The lamp according to claim 1, wherein the at least one moving part comprises at least one part movably attached to the at least one stationary part.

5. The lamp according to claim 1, wherein the at least one moving part comprises at least one functional element contributing to a light performance of the lamp.

6. The lamp according to claim 5, wherein the at least one moving part comprises at least one beam shaping element for shaping a radiation pattern of the lamp.

7. The lamp according to claim 1, wherein:
the motion detection system is configured to capture information about at least one of a direction, a motion angle, a motion speed, and a direction variation speed of the at least one moving part; and
the control module is configured to control the at least one light source at least partially based on said information captured by the motion detection system

8. The lamp according to claim 7, wherein the motion of the at least one moving part captured by the motion detection system comprises a motion pattern of the at least one moving part.

9. The lamp according to claim 1, wherein the lamp is a configurable lamp with a variable lighting configuration.

10. The lamp according to claim 9, wherein the lamp comprises one or more built-in lighting configuration modules configured to change the variable lighting configuration at least partially based on the motion of the at least one moving part captured by the motion detection system.
